(19) United States
(12) Patent Application Publication
(10) Pub. No.: US 2024/0290508 A1
(43) Pub. Date: Aug. 29, 2024

(54) METHOD FOR MANUFACTURING MULTI-LAYERED NUCLEAR FUEL CLADDING AND MULTI-LAYERED NUCLEAR FUEL CLADDING PRODUCED THEREBY

(71) Applicants: GACHON UNIVERSITY OF INDUSTRY-ACADEMIC COOPERATION FOUNDATION, Seongnam-si, Gyeonggi-do (KR); KOREA ADVANCED INSTITUTE OF SCIENCE AND TECHNOLOGY, Daejeon (KR)

(72) Inventors: Young Soo Yoon, Gwacheon-si, Gyeonggi-do (KR); Yong Hee KIM, Daejeon (KR); Ji-Hyeok CHOI, Yongin-si, Gyeonggi-do (KR); Unho LEE, Uijeongbu-si, Gyeonggi-do (KR); Ha Eun KANG, Seongnam-si, Gyeonggi-do (KR)

(21) Appl. No.: 18/420,941

(22) Filed: Jan. 24, 2024

(30) Foreign Application Priority Data
Feb. 3, 2023 (KR) 10-2023-0014665

(51) Int. Cl. G21C 3/07; G21C 3/20

(52) U.S. Cl. CPC G21C 3/07; G21C 3/20

(57) ABSTRACT

A method for manufacturing a multi-layered nuclear fuel cladding, the method including the steps of: preparing a preliminary cladding by inserting an inner tube into a zirconium alloy tube extending in a first axial direction in such a way as to allow the inner tube to be coaxially arranged with the zirconium alloy tube and by fitting an outer tube to the zirconium alloy tube in such a way as to allow the outer tube to be coaxially arranged with the zirconium alloy tube; inserting a bullet-shaped insertion body whose both end portions have different outer diameters into the inner tube; and applying a given force to the preliminary cladding to reduce the thickness and diameter of the preliminary cladding, wherein at least one of the inner tube and the outer tube is made from a ferrous or non-ferrous metal.

### CROSS REFERENCE TO RELATED APPLICATION OF THE DISCLOSURE

The present application claims the benefit of Korean Patent Application No. 10-2023-0014665 filed in the Korean Intellectual Property Office on Feb. 3, 2023, the entire contents of which are incorporated herein by reference.

### BACKGROUND OF THE DISCLOSURE

### Field of the Disclosure

The present disclosure relates to a method for manufacturing a multi-layered nuclear fuel cladding and a multi-layered nuclear fuel cladding produced thereby, more particularly to a method for manufacturing a multi-layered nuclear fuel cladding that is capable of manufacturing the multi-layered nuclear fuel cladding made from a zirconium alloy and a ferrous or non-ferrous metal using a bullet-shaped insertion body and to a multi-layered nuclear fuel cladding produced thereby.

### Background of the Related Art

Generally, a nuclear power plant is a type of power plant that generates steam from heat produced by nuclear fission, rotates a turbine with the force of the steam generated, and generates electricity, and to prevent radioactive materials from leaking to the outside from the nuclear power plant and ensure the safety of the nuclear power plant, the nuclear power plant has multi-layered shield walls. Among them, a nuclear fuel cladding as a secondary shield wall serves to surround a nuclear fuel pellet in such a way as to allow the nuclear fuel that has nuclear fission with a coolant of a primary system calculated along a nuclear reactor to be isolated from the coolant, thereby preventing the fission products generated during the nuclear fission reaction from being transferred to the coolant of the primary system and effectively transferring the heat produced by the nuclear fission to the coolant of the primary system.

Great thermal energy is generated from a nuclear reactor core in which the nuclear fuel claddings are put due to the nuclear fission chain reactions of the nuclear fuels, and accordingly, the coolant of the primary system, which is calculated along the nuclear reactor, receives the thermal energy and thus evaporates water of a secondary system. Further, the coolant cools the heat generated from the nuclear reactor core due to the nuclear fission reaction, while being circulated inside the nuclear reactor.

Fukushima nuclear power plant accident happens due to stop of the circulation of a coolant when power supply is blocked, and like this, if the coolant is not supplied well due to the failure of a cooling system for cooling the great heat generated by the nuclear fission, a nuclear reactor pressure container in which the nuclear reactor core is accommodated becomes drastically raised in internal temperature thereof. Further, the materials of the nuclear fuel cladding react with high temperature steam to cause rapid oxidation. Besides, the radioactive materials as the nuclear fission products may leak to the outside due to high temperature oxidation and corrosion of the nuclear fuel cladding, and accordingly, the exchange period of the nuclear fuel cladding becomes shortened to cause economical loss. As the nuclear fuel cladding becomes brittle due to the rapid oxidation, further, the ductility of the materials of the nuclear fuel cladding becomes decreased to threaten the stability of a nuclear fuel assembly.

Therefore, there is a definite need for developing a method for manufacturing a nuclear fuel cladding that is capable of overcoming such disadvantages, while having excellent thermal stability.

### SUMMARY OF THE DISCLOSURE

Accordingly, the present disclosure has been made in view of the above-mentioned problems occurring in the related art, and it is an object of the present disclosure to provide a method for manufacturing a multi-layered nuclear fuel cladding that is capable of manufacturing the multi-layered nuclear fuel cladding made from a zirconium alloy and a ferrous or non-ferrous metal using a bullet-shaped insertion body, thereby ensuring the multi-layered nuclear fuel cladding having excellent thermal stability at a high temperature.

It is another object of the present disclosure to provide a multi-layered nuclear fuel cladding that is capable of being made from a zirconium alloy and a ferrous or non-ferrous metal, while being produced by the method as mentioned above.

The technical problems to be achieved through the present disclosure are not limited as mentioned above, and other technical problems not mentioned herein will be obviously understood by one of ordinary skill in the art through the following description.

To accomplish the above-mentioned objects, according to one aspect of the present disclosure, there is provided a method for manufacturing a multi-layered nuclear fuel cladding, the method including the steps of: preparing a preliminary cladding by inserting an inner tube into a zirconium alloy tube extending in a first axial direction in such a way as to allow the inner tube to be coaxially arranged with the zirconium alloy tube and by fitting an outer tube to the zirconium alloy tube in such a way as to allow the outer tube to be coaxially arranged with the zirconium alloy tube; inserting a bullet-shaped insertion body whose both end portions have different outer diameters into the inner tube; and applying a given force to the preliminary cladding to reduce the thickness and diameter of the preliminary cladding, wherein at least one of the inner tube and the outer tube is made from a ferrous or non-ferrous metal.

According to the present disclosure, desirably, the ferrous or non-ferrous metal may include 10 to 20% by weight of chromium (Cr), 5 to 20% by weight of nickel (Ni), and 1 to 5% by weight of molybdenum (Mo).

According to the present disclosure, desirably, the step of preparing the preliminary cladding may further include the step of forming a zirconium nitride layer on at least one among the inner peripheral surface and (or) the outer peripheral surface of the zirconium alloy tube, the outer peripheral surface of the inner tube, and the inner peripheral surface of the outer tube.

According to the present disclosure, desirably, the step of forming the zirconium nitride layer may be performed by means of gas nitriding, plasma nitriding, or heat nitriding at a temperature in the range of a room temperature to 2500° C.

According to the present disclosure, desirably, the method may further include the step of forming, after the step of reducing the thickness and diameter of the preliminary cladding, a zirconium nitride layer on at least one of the interface between the zirconium alloy tube and the inner tube and the interface between the zirconium alloy tube and the outer tube.

According to the present disclosure, desirably, the step of forming the zirconium nitride layer may be performed by means of thermal treatment in the range of 300 to 1000° C. for 1 to 50 hours.

According to the present disclosure, desirably, a mean thickness of the zirconium nitride layer of the multi-layered nuclear fuel cladding may be in the range of 0.01 to 100 μm.

According to the present disclosure, desirably, a thickness ratio of the zirconium nitride layer to the zirconium alloy tube of the multi-layered nuclear fuel cladding may be 1:100 to 250.

According to the present disclosure, desirably, the insertion body may include: a front end portion having the shape of a cylinder with a first outer diameter; a rear end portion having the shape of a cylinder with a second outer diameter larger than the first outer diameter; and an inclined portion for connecting the front end portion and the rear end portion to each other, and the step of inserting the insertion body into the inner tube may be performed by first inserting the front end portion into the inner tube.

According to the present disclosure, desirably, the step of reducing the thickness and diameter of the preliminary cladding may include the steps of: inserting the preliminary cladding into a through hole formed on a die fixed to a given position, the though hole having an inner peripheral shape corresponding to the outer peripheral shape of the insertion body; and drawing the front end portion of the preliminary cladding along the first axial direction.

According to the present disclosure, desirably, the through hole may include: a first through hole having the shape of a cylinder with a first inner diameter; a second through hole having the shape of a cylinder with a second inner diameter larger than the first inner diameter; and an inclined tube hole for connecting the first through hole and the second through hole, and the first inner diameter being larger than the first outer diameter of the insertion body, the second inner diameter being larger than the second outer diameter of the insertion body, and the second outer diameter of the insertion body being larger than the first inner diameter.

According to the present disclosure, desirably, the step of reducing the thickness and diameter of the preliminary cladding may further include the step of reducing the front end portion of the preliminary cladding in such a way as to allow the front end portion of the preliminary cladding to be inserted into the through hole and then protrude outward from the front end portion of the die.

According to the present disclosure, desirably, the hardness of the insertion body and the die may be 2 to 5 times greater than the mean hardness of the preliminary cladding.

According to the present disclosure, desirably, the method may further include at least one of steps of grinding the surface of the insertion body and applying a lubricant to the surface of the insertion body.

According to the present disclosure, desirably, a difference between the first outer diameter and the second outer diameter of the insertion body may be less than or equal to 10 mm.

According to the present disclosure, desirably, the inclined portion may have an inclination in the range of 10 to 35° with respect to the extension line of the outer peripheral surface of the front end portion.

According to the present disclosure, desirably, the height of the front end portion may be 1/10 to ⅓ of the entire height of the insertion body.

According to the present disclosure, desirably, the step of reducing the thickness and diameter of the preliminary cladding may further include the step of grinding and (or) polishing the preliminary cladding.

According to the present disclosure, desirably, the step of preparing the preliminary cladding may further include the step of grinding or polishing the zirconium alloy tube, the preliminary cladding, the inner tube, or the outer tube.

To accomplish the above-mentioned objects, according to another aspect of the present disclosure, there is provided a multi-layered nuclear fuel cladding including: a zirconium alloy tube extending in a first axial direction; a hollow inner tube coaxially arranged with the zirconium alloy tube in such a way as to be inserted into the zirconium alloy tube; and an outer tube coaxially arranged with the zirconium alloy tube in such a way as to be fitted to the outer peripheral surface of the zirconium alloy tube, wherein at least one of the inner tube and the outer tube may be made from a ferrous or non-ferrous metal.

According to the present disclosure, desirably, the ferrous or non-ferrous metal may include 10 to 20% by weight of chromium (Cr), 5 to 20% by weight of nickel (Ni), and 1 to 5% by weight of molybdenum (Mo).

According to the present disclosure, desirably, the multi-layered nuclear fuel cladding may further include a zirconium nitride layer formed on at least one of the interface between the zirconium alloy tube and the inner tube and the interface between the zirconium alloy tube and the outer tube.

According to the present disclosure, desirably, the mean thickness of the zirconium nitride layer may be in the range of 0.1 to 3 μm.

According to the present disclosure, desirably, a thickness ratio of the zirconium nitride layer to the zirconium alloy tube of the multi-layered nuclear fuel cladding may be 1:100 to 250.

According to the present disclosure, desirably, the thickness of the outer tube may be in the range of 10 to 80 μm.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIGS. 1A to 1C are schematic perspective views showing a method for manufacturing a multi-layered nuclear fuel cladding according to an embodiment of the present disclosure;

FIGS. 2A and 2B are sectional and top views showing the multi-layered nuclear fuel cladding made by the method according to the embodiment of the present disclosure;

FIG. 3 is a schematic view showing centerless grinding for reducing the outer diameter of the nuclear fuel cladding according to the embodiment of the present disclosure;

FIG. 4 is a schematic view showing grinding on a lathe for reducing the outer diameter of the nuclear fuel cladding according to the embodiment of the present disclosure;

FIG. 5 is a schematic view showing changes in the outer diameters of the nuclear fuel cladding before and after the grinding according to the present disclosure (wherein the left view shows the outer diameter before the grinding and the right view shows the outer diameter after the grinding);

FIG. 6 shows the optical microscope images of the sections of nuclear fuel claddings of a Comparative example 1 (the left) and Embodiment 1 of the present disclosure (the right);

FIG. 7 shows outer shapes, after high temperature tests, of the nuclear fuel claddings of Comparative example 1 and Embodiment 1 of the present disclosure; and

FIG. 8 shows the optical microscope images of the nuclear fuel claddings of Comparative example 1 (the left) and Embodiment 1 of the present disclosure (the right), after the high temperature tests.

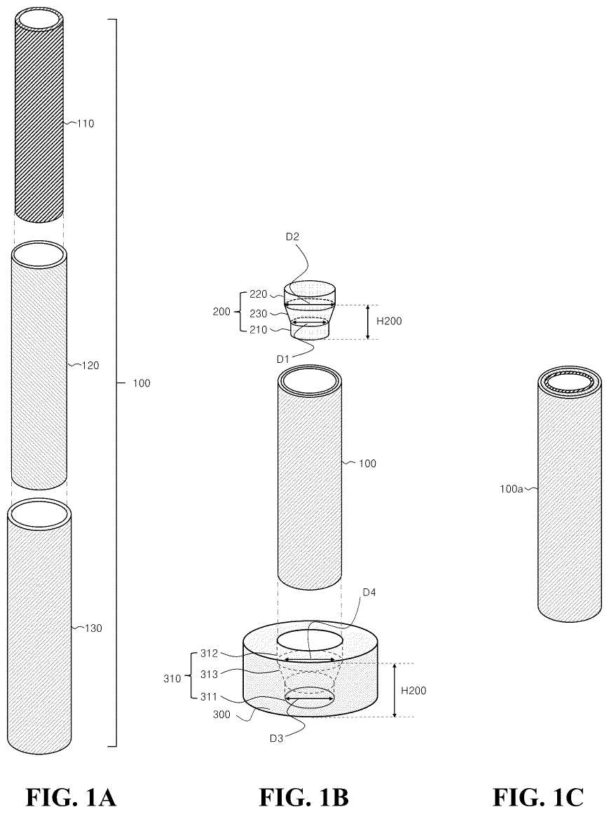

### DETAILED DESCRIPTION OF THE EMBODIMENTS

Hereinafter, an explanation of the present disclosure will be given in detail with reference to the attached drawings. Before the present disclosure is disclosed and described, it is to be understood that the disclosed embodiments are merely exemplary of the disclosure, which can be embodied in various forms. In order to facilitate the general understanding of the present disclosure in describing the present disclosure, through the accompanying drawings, the same reference numerals will be used to describe the same components and the thicknesses of the lines or the sizes of the components shown in the drawing may be magnified for the clarity and convenience of the description.

When it is said that one element is described as being “connected” or “coupled” to the other element, one element may be directly connected or coupled to the other element, but it should be understood that another element may be present between the two elements. In the description, when it is said that one portion is described as “includes” any component, one element further may include other components unless no specific description is suggested.

Terms used in this application are used to only describe specific exemplary embodiments and are not intended to restrict the present disclosure. An expression referencing a singular value additionally refers to a corresponding expression of the plural number, unless explicitly limited otherwise by the context. In this application, terms, such as “comprise”, “include”, or ‘have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

In the present disclosure, the steps may be differently carried out from the described order unless a specific order is described. That is, the steps may be carried out in the same order as described, carried out at the same time, or carried out in the opposite order to that described.

According to a first aspect of the present disclosure, a method for manufacturing a multi-layered nuclear fuel cladding is provided.

The method for manufacturing a multi-layered nuclear fuel cladding according to the first aspect of the present disclosure includes the steps of: preparing a preliminary cladding 100 by inserting an inner tube 110 into a zirconium alloy tube 120 extending in a first axial direction in such a way as to allow the inner tube 110 to be coaxially arranged with the zirconium alloy tube 120 and by fitting an outer tube 130 to the zirconium alloy tube 120 in such a way as to allow the outer tube 130 to be coaxially arranged with the zirconium alloy tube 120; inserting a bullet-shaped insertion body 200 whose both end portions have different outer diameters into the inner tube 110; and applying a force to the preliminary cladding 100 to reduce the thickness and diameter of the preliminary cladding 100, wherein at least one of the inner tube 110 and the outer tube 130 is made from a ferrous or non-ferrous metal.

According to one embodiment of the present disclosure, the ferrous or non-ferrous metal comprises, for example, 10 to 25% by weight of chromium (Cr), 5 to 20% by weight of nickel (Ni), and 0.1 to 10% by weight of molybdenum (Mo). According to another embodiment of the present disclosure, the ferrous or non-ferrous metal comprises 11, 12, or 13% or more and otherwise 24, 23, or 22% or less by weight of chromium (Cr), 6, 7, or 8% or more and otherwise 19, 18, or 17% or less by weight of nickel (Ni), and 0.3, 0.5, or 0.7% or more and otherwise 9, 8, or 7% or less by weight of molybdenum (Mo). Desirably, the ferrous or non-ferrous metal is stainless steel.

According to one embodiment of the present disclosure, the step of preparing the preliminary cladding 100 further includes the step of forming a zirconium nitride layer on at least one among the inner peripheral surface and (or) the outer peripheral surface of the zirconium alloy tube, the outer peripheral surface of the inner tube, and the inner peripheral surface of the outer tube.

According to one embodiment of the present disclosure, the step of forming the zirconium nitride layer is performed by means of gas nitriding, plasma nitriding, or heat nitriding at a temperature in the range of a room temperature to 2500° C., desirably at a temperature in the range of 450 to 2000° C. According to another embodiment of the present disclosure, the step of forming the zirconium nitride layer is performed at a temperature of 500, 600, or 700° C. or more and otherwise at a temperature of 1900, 1800, or 1700° C. or less.

According to one embodiment of the present disclosure, the gas nitriding is a surface treatment process in which nitrogen dissolved by the thermal and chemical reaction of a gas is diffusedly introduced into the surface of a steel part. Further, the plasma nitriding is a method for injecting nitrogen gas and hydrogen gas into a vacuum chamber, applying a voltage of 400 to 800 volts to a space between a parent material as a material to be treated connected electrically to a cathode and a chamber acting as an anode, and forming a nitride layer by means of the plasma generated around the material to be treated, and the plasma discharge activates the introduction of nitrogen atoms into the surface of the material to be treated, so that the nitride layer is formed on the surface. In this case, the nitrogen gas is ionized to produce plasma with violet light, and accordingly, the entire surface of the material to be treated is coated with the plasma. Further, gas ions having high energy are accelerated at high speeds and collide against the surface of the material to be treated by means of drastic cathode sheath in front of the surface of the material to be treated. Because of such ion collision, kinetic energy is converted into thermal energy, thereby increasing the temperature of the surface of the material to be treated.

According to one embodiment of the present disclosure, after the step of reducing the thickness and diameter of the preliminary cladding, the method according to the present disclosure further comprises the step of forming a zirconium nitride layer on at least one of the interface between the zirconium alloy tube 120 and the inner tube 110 and the interface between the zirconium alloy tube 120 and the outer tube 130.

According to one embodiment of the present disclosure, the step of forming the zirconium nitride layer is performed by means of thermal treatment in the range of 300 to 1000° C. According to another embodiment of the present disclosure, the step of forming the zirconium nitride layer is performed at a temperature of 310, 320, or 330° C. or more and otherwise at a temperature of 900, 800, 700, 600, or 500° C. or less.

According to one embodiment of the present disclosure, the step of forming the zirconium nitride layer is performed by means of thermal treatment for 1 to 50 hours. According to another embodiment of the present disclosure, the step of forming the zirconium nitride layer is performed by means of thermal treatment for 1, 5, 10, or 15 hours or more and otherwise for 50, 45, 40, 35, or 30 hours or less.

According to one embodiment of the present disclosure, the mean thickness of the zirconium nitride layer is, for example, in the range of 0.01 to 100 μm. According to another embodiment of the present disclosure, the mean thickness of the zirconium nitride layer is 0.02, 0.03, or 0.04 μm or more and otherwise 90, 80, or 70 μm or less. The control of the mean thickness within the above-mentioned range enables the zirconium nitride having the characteristics of a wide neutron absorption spectrum to be kept to a small neutron absorption cross section. Contrarily, if the mean thickness of the zirconium nitride layer is less than 0.01 μm, corrosion resistance becomes low to cause transition of oxidation reaction.

According to one embodiment of the present disclosure, a thickness ratio of the zirconium nitride layer to the zirconium alloy tube is, for example, 1:100 to 250. According to another embodiment of the present disclosure, a thickness ratio of the zirconium nitride layer to the zirconium alloy tube is 1:120, 140, 160, or 180 or more and otherwise 1:240, 230, 220, 210, or 200 or less. The control of the thickness ratio of the zirconium nitride layer to the zirconium alloy tube within the above-mentioned range prevents a gap between the zirconium alloy tube and the outer tube or between the zirconium alloy tube and the inner tube from being generated after drawing and reduction processes through high volume expansivity of zirconium nitride.

According to one embodiment of the present disclosure, a thickness ratio of the zirconium nitride layer to the outer tube is 1:10 to 20. According to another embodiment of the present disclosure, a thickness ratio of the zirconium nitride layer to the outer tube is 1:11, 12, or 13 or more and otherwise 1:19, 18, or 17 or less.

According to one embodiment of the present disclosure, a thickness ratio of the zirconium nitride layer to the inner tube is 1:10 to 20. According to another embodiment of the present disclosure, a thickness ratio of the zirconium nitride layer to the inner tube is 1:11, 12, or 13 or more and otherwise 1:19, 18, or 17 or less.

According to one embodiment of the present disclosure, the insertion body 200 includes a front end portion 210 having the shape of a cylinder with a first outer diameter; a rear end portion 220 having the shape of a cylinder with a second outer diameter larger than the first outer diameter; and an inclined portion 230 for connecting the front end portion 210 and the rear end portion 220 to each other, and the step of inserting the bullet-shaped insertion body 200 into the inner tube 110 is performed by first inserting the front end portion 210 into the inner tube 110.

According to one embodiment of the present disclosure, the step of preparing the preliminary cladding 100 made with the inner tube 110, the zirconium alloy tube 120, and the outer tube 130 and the step of inserting the bullet-shaped insertion body 200 into the inner tube 110 are performed simultaneously.

According to one embodiment of the present disclosure, the outer diameter D2 of the rear end portion 220 of the insertion body 200 corresponds to the inner diameter of the inner tube 110 of the preliminary cladding 100 being in a state before the thickness and diameter thereof are reduced, and the outer diameter D1 of the front end portion 210 of the insertion body 200 corresponds to the inner diameter of an inner tube 110″ of the multi-layered nuclear fuel cladding 100a being in a state after the thickness and diameter thereof have been reduced. In this case, the rear end portion 220 having the shape of the cylinder, which is kept to the outer diameter D2, serves to coaxially align the inner tube 110, the zirconium alloy tube 120, and the outer tube 130 of the preliminary cladding 100 before the thickness and diameter of the preliminary cladding 100 are reduced, while firmly supporting them, so that while the thickness and diameter of the preliminary cladding 100 are being reduced, the rear end portion 220 uniformly provides a reaction force to the inner peripheral surface of the preliminary cladding 100.

According to one embodiment of the present disclosure, the front end portion 210 having the shape of the cylinder, which is kept to the outer diameter D1, serves to allow the process of reducing the thickness and diameter of the preliminary cladding 100 to be stably performed to make the multi-layered nuclear fuel cladding 100a having the uniform properties of the outer peripheral surface thereof, and further, the front end portions having various outer diameters D1 may be selectively used to allow the thickness and diameter of the multi-layered nuclear fuel cladding 100a to be easily adjusted.

While the front end portion 210 is being inserted into the inner tube 110, moreover, a given force is applied from the front end portion 210 to the inner peripheral surface of the inner tube 110, so that the inner peripheral surface of the inner tube 110″ is smoothly processed.

Further, the process of reducing the thickness and diameter of the preliminary cladding 100 is carried out in a section where the outer diameter of the insertion body 200 is varied between the front end portion 210 and the rear end portion 220 having different outer diameters from each other, and to prevent drastic stress from occurring on the preliminary cladding 100, in this case, the insertion body 200 has the inclined portion 230 adapted to connect the front end portion 210 and the rear end portion 220 to each other in such a way as to gently reduce the outer diameter thereof from the second outer diameter D2 to the first outer diameter D1.

According to one embodiment of the present disclosure, the step of reducing the thickness and diameter of the preliminary cladding 100 includes the steps of: inserting the preliminary cladding 100 into a through hole 310 formed on a die 300 fixed to a given position, the though hole 310 having an inner peripheral shape corresponding to the outer peripheral shape of the bullet-shaped insertion body 200; and drawing the front end portion of the preliminary cladding 100 along the first axial direction.

According to one embodiment of the present disclosure, the die 300 has the though hole 310 having the inner peripheral shape corresponding to the outer peripheral shape of the bullet-shaped insertion body 200, and in detail, the front end portion of the through hole 310 has the inner diameter corresponding to the outer diameter of the multi-layered nuclear fuel cladding 100a, whereas the rear end portion of the through hole 310 has the inner diameter corresponding to the outer diameter of the preliminary cladding 100. The die 300 is fixed to the given position such as a frame, without any movement.

According to one embodiment of the present disclosure, a drawing machine 400 grasps the front end portion of the preliminary cladding 100 whose at least a portion is inserted into the through hole 310 and draws the front end portion of the preliminary cladding 100 in the first axial direction. If the front end portion of the preliminary cladding 100 is drawn, it is supported against the front end portion of the through hole 310 that has a smaller outer diameter than the rear end portion of the through hole 310, thereby allowing a tensile force to be applied to the preliminary cladding 100 to cause the preliminary cladding 100 to be drawn. In this case, the die 300 applies a given force to the inner peripheral surface of the preliminary cladding 100 from the outer peripheral surface thereof, and the insertion body 200 applies a given force for supporting the inner tube 110 against the given force applied to the inner peripheral surface of the preliminary cladding 100 from the outer peripheral surface thereof, so that while the thickness and diameter of the preliminary cladding 100 are being reduced, the outer tube 130 and the inner tube 110 are fixedly brought into close contact with the zirconium alloy tube 120, thereby making the multi-layered nuclear fuel cladding 100a having no distortion. The thickness and diameter of the multi-layered nuclear fuel cladding 100a made are easily determined according to the shapes and sizes of the insertion body 200 and the through hole 310 of the die 300.

According to one embodiment of the present disclosure, a method for applying the force to the preliminary cladding 100 is performed by applying the tensile force to the preliminary cladding 100 in the first axial direction through the drawing machine to cause the force generated from the outer radial direction of the preliminary cladding 100 to the inner radial direction thereof to be induced toward the central axis of the preliminary cladding 100 in the first axial direction. Otherwise, a plurality of pressurizing members each having a pair of rollers are arranged in the first axial direction, and the preliminary cladding 100 pressurizedly moves between the rollers, thereby applying the force toward the central axis of the preliminary cladding 100. The method for applying the force to the preliminary cladding 100 may not be limited to the above-mentioned methods, but it may be differently performed.

According to one embodiment of the present disclosure, the step of reducing the thickness and diameter of the preliminary cladding 100 is performed by applying the force generated from the outer radial direction of the preliminary cladding 100 to the inner radial direction thereof to be induced toward the central axis of the preliminary cladding 100 in the first axial direction, thereby allowing the inner tube and the outer tube to be fixedly brought into close contact with each other. In this case, the insertion body 200 applies the force for supporting the inner tube 110 against the force applied to the inner peripheral surface of the preliminary cladding 100 from the outer peripheral surface thereof.

According to one embodiment of the present disclosure, the through hole 310 includes: a first through hole 311 having the shape of a cylinder with a first inner diameter; a second through hole 312 having the shape of a cylinder with a second inner diameter larger than the first inner diameter; and an inclined tube hole 313 for connecting the first through hole 311 and the second through hole 312 to each other. The first inner diameter is larger than the first outer diameter of the insertion body, the second inner diameter is larger than the second outer diameter of the insertion body, and the second outer diameter of the insertion body is larger than the first inner diameter. A distance between the first inner diameter D3 of the first through hole 311 and the first outer diameter D1 of the insertion body 200 and a distance between the second inner diameter D4 of the second through hole 312 and the second outer diameter D2 of the insertion body 200 are determined according to the thickness and diameter of the preliminary cladding 100 and the thickness and diameter of the multi-layered nuclear fuel cladding 100a. To allow the insertion body 200 to apply the force to the inner tube 110, while being supported against the inner tube 110, without passing through the die 300, while the front end portion of the preliminary cladding 100 is being drawn, the second outer diameter D2 of the insertion body 200 is larger than the first inner diameter D3 of the first through hole 311. The insertion body 200 applies the force to the inner peripheral surface of the inner tube 110, while being supported against the inner tube 110, without moving together with the preliminary cladding 100 drawn by the die 300, so that the thickness and diameter of the preliminary cladding 100 are continuously reduced, irrespective of the length of the preliminary cladding 100, thereby allowing the inner tube 110 and the outer tube 130 to be fixedly brought into close contact with the zirconium alloy tube 120. If the other end portion of the preliminary cladding 100 that faces the drawn front end portion of the preliminary cladding 100 passes through the die 300, the insertion body 200 does not pass through the die 300 and is thus removed automatically to the outside from the preliminary cladding 100, without any additional device or process.

According to one embodiment of the present disclosure, the method according to the present disclosure further includes the step of reducing the front end portion of the preliminary cladding 100 in such a way as to allow the front end portion of the preliminary cladding 100 to be inserted into the through hole 310 and then protrude outward from the front end portion of the die 300.

According to one embodiment of the present disclosure, the hardness of the insertion body 200 and the die 300 is, for example, 2 to 5 times greater than the mean hardness of the preliminary cladding 100. According to another embodiment of the present disclosure, the hardness of the insertion body 200 and the die 300 is, for example, 2.2 or 2.5 times greater than or equal to the mean hardness of the preliminary cladding 100 and otherwise 4.8 or 4.5 times less than or equal to the mean hardness of the preliminary cladding 100. If the hardness of the insertion body 200 and the die 300 is 2 times less than the mean hardness of the preliminary cladding 100 (the inner tube 110 and the outer tube 130), the insertion body 200 and the die 300 may be deformed due to accumulation of consistent mechanical stress, and if the hardness of the insertion body 200 and the die 300 is 5 times greater than the mean hardness of the preliminary cladding 100, the bullet-shaped insertion body 200 and the die 300 having the bullet-shaped through hole 310 may be hard to be precisely made, thereby making it difficult to make the multi-layered nuclear fuel cladding having uniform thickness and diameter.

According to one embodiment of the present disclosure, the method according to the present disclosure further includes at least one of steps of grinding the surface of the bullet-shaped insertion body 200 or applying a lubricant to the surface of the bullet-shaped insertion body 200. If the surface of the insertion body 200 is rough, the inner peripheral surface of the inner tube 110 may be scratched due to the rough surface of the insertion body 200, and further, the inner tube 110 may be torn off or damaged due to the friction between the inner peripheral surface thereof and the surface of the insertion body 200, thereby causing the defect on the inner tube 110. To solve such problems, the surface of the insertion body 200 is ground or coated with a lubricant. To reduce the heat and friction force generated in the process of drawing the front end portion of the preliminary cladding 100, additionally, the method according to the present disclosure further includes the step of applying the lubricant to a space between the preliminary cladding 100 and the die 300. The type of lubricant may include one or more lubricants selected from the group consisting of a liquid lubricant, a solid lubricant, a semi-solid lubricant, and a combination thereof, without being limited specially thereto.

According to one embodiment of the present disclosure, a difference between the first outer diameter D1 and the second outer diameter D2 of the insertion body 200 is, for example, less than or equal to 10 mm. According to another embodiment of the present disclosure, a difference between the first outer diameter D1 and the second outer diameter D2 of the insertion body 200 is less than or equal to 9, 8, or 7 mm. Only if the lower limit value of the difference is greater than 0, it does not matter. For example, the difference is greater than or equal to 0.01, 0.05, or 0.1 mm. If the difference between the first outer diameter D1 and the second outer diameter D2 is too big, a relatively large force is applied to the preliminary cladding 100 in the step of reducing the thickness and diameter of the preliminary cladding 100 to cause high stress and many mechanical defects on the preliminary cladding 100. Accordingly, the difference between the first outer diameter D1 and the second outer diameter D2 is controlled in the above-mentioned range, thereby effectively suppressing stress from being generated on the preliminary cladding 100.

In the same manner as above, a difference (D4-D3) between the first inner diameter D3 of the first through hole 311 determined by the outer diameter of the multi-layered nuclear fuel cladding 100a and the second inner diameter D4 of the second through hole 312 determined by the outer diameter of the preliminary cladding 100 is less than or equal to 10 mm, and if a difference between the outer diameter of the preliminary cladding 100 and the outer diameter as required of the multi-layered nuclear fuel cladding 100a is too big, a plurality of dies 300 having a difference between the outer diameter D3 and the outer diameter D4 less than or equal to 10 mm are used sequentially in order of being reducing in inner diameters thereof, thereby reducing the damages occurring on the multi-layered nuclear fuel cladding 100a.

According to one embodiment of the present disclosure, the inclined portion 230 has, for example, an inclination in the range of 10 to 35° with respect to the extension line of the outer surface of the front end portion 210. According to another embodiment of the present disclosure, the inclined portion 230 has an inclination of 11, 12, or 13° or more and otherwise 34, 33, or 32° or less with respect to the extension line of the outer surface of the front end portion 210. If the inclination is less than 10°, the section of the inclined portion 230 for connecting the rear end portion 220 and the front end portion 210 to each other is too long to cause the entire length of the insertion body 200 to extend, thereby increasing the friction force between the inner peripheral surface of the preliminary cladding 100 and the insertion body 100 to cause a lot of stress and heat to be generated from the inner peripheral surface of the preliminary cladding 100. Contrarily, if the inclination is over 35°, the outer diameter of the insertion body 200 is drastically varied to cause rapid stress on the section of the inclined portion to be collected to the preliminary cladding 100, thereby making the preliminary cladding 100 torn off or causing mechanical damages on the inner peripheral surface of the preliminary cladding 100.

According to one embodiment of the present disclosure, the height of the front end portion 210 is, for example, 1/10 to ⅓ of the entire height of the bullet-shaped insertion body 200. According to another embodiment of the present disclosure, the height of the front end portion 210 is greater than or equal to 2/10, 3/10, or 4/10 and otherwise less than or equal to 3/12, 2/12, or 1/12 of the entire height of the bullet-shaped insertion body 200. The cylindrical front end portion 210 keeping the same outer diameter D1 serves to allow the step of reducing the thickness and diameter of the preliminary cladding 100 to be performed stably and sufficiently to make the multi-layered nuclear fuel cladding 100a having the uniform properties of the outer peripheral surface thereof and apply a constant force to the inner peripheral surface of the inner tube 110, while the inner tube 110 is passing therethrough, to allow the inner peripheral surface of the inner tube 110″ to be smoothly processed. To enable the operations of the front end portion 210 to be performed well, the front end portion 210 has to keep the same outer diameter D1 over the height section in the above-mentioned range. If the height of the front end portion 210 is less than 1/10 of the height H200 of the insertion body 200, a section of constantly pressurizing the inner peripheral surface of the preliminary cladding 100, while keeping the inner diameter of the preliminary cladding 100, is not sufficient. Contrarily, if the height of the front end portion 210 is greater than ⅓ of the height H200 of the insertion body 200, the lengths (heights) of the rear end portion 220 and the inclined portion 230 of the insertion body 200 relatively decrease so that the rear end portion 220 fails to firmly support the inner tube 110, the zirconium alloy tube 120, and the outer tube 130 of the preliminary cladding 100 before the thickness and diameter thereof are reduced, while coaxially aligning them, and further, the inclined portion 230 fails to release the drastic stress applied to the preliminary cladding 100.

According to one embodiment of the present disclosure, the step of reducing the thickness and diameter of the preliminary cladding further includes the step of grinding and (or) polishing the preliminary cladding.

According to one embodiment of the present disclosure, further, the step of preparing the preliminary cladding 100 further includes the step of grinding or polishing the zirconium alloy tube, the preliminary cladding, the inner tube, or the outer tube.

According to one embodiment of the present disclosure, the grinding and (or) polishing step serves to finely adjust the thickness of the zirconium alloy tube, the preliminary cladding, the inner tube, or the outer tube, and the grinding and (or) polishing step is performed by a grinding wheel, a regulating wheel, and a cutting tool. In this case, a grinding and (or) polishing method may not be limited specially, but it may be performed by means of centerless grinding or grinding on a lathe.

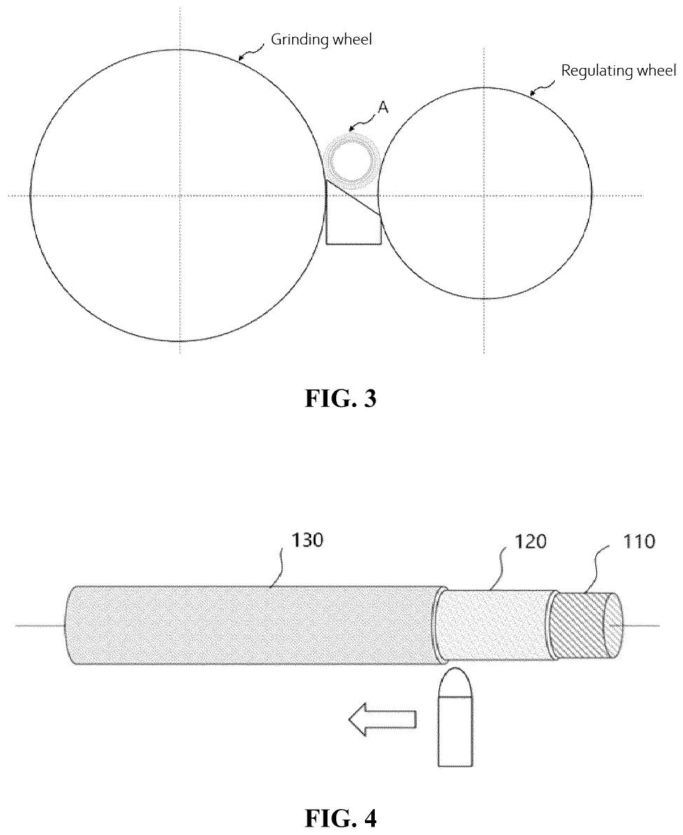

According to one embodiment of the present disclosure, as shown in FIG. 3, the centerless grinding is performed in a state where an object A to be subjected to grinding and (or) polishing is inserted into a space between the regulating wheel and the grinding wheel, without being fixed to a chuck, while the object A is being supported against a support plate.

According to one embodiment of the present disclosure, the grind on a lathe is performed in a state where rotary motions are applied to the object to be subjected to grinding and (or) polishing, while the cutting tool is performing linear motions in forward and backward or left and right directions to cut the object to the shape of the cylinder. In this case, after grinding and (or) polishing for the object has been completed, the preliminary cladding 100 is prepared, and otherwise, the step of preparing the preliminary cladding 100 with the inner tube 110, the zirconium alloy tube 120, and the outer tube 130 arranged and the grinding and (or) polishing step are performed simultaneously, as shown in FIG. 4. Further, the grinding and (or) polishing step is used to easily weld a cladding cap. Moreover, the thickness varied through the grinding and (or) polishing step is adjusted to the maximum 50 μm or less, and grinding and (or) polishing may be performed a plurality of times within a desired thickness adjustment range, without being limited specially.

According to one embodiment of the present disclosure, a support 500 is provided to support the preliminary cladding 100 to prevent the preliminary cladding 100 from being bent due to its self-weight if the length of the preliminary cladding 100 is long.

Further, a lubricant applicator 600 is provided to apply the lubricant to a space between the preliminary cladding 100 and the die 300 to reduce the heat and friction force generated in the step of drawing the front end portion of the preliminary cladding 100.

According to another aspect of the present disclosure, the multi-layered nuclear fuel cladding made by the above method is provided.

An explanation of the parts repeated with those according to one aspect of the present disclosure will be avoided below, but the explanation of one aspect of the present disclosure may be given in the same manner as of another aspect of the present disclosure unless additionally mentioned herein.

The multi-layered nuclear fuel cladding made by the method according to one aspect of the present disclosure includes: a zirconium alloy tube 120 extending in a first axial direction; a hollow inner tube 110 coaxially arranged with the zirconium alloy tube 120 in such a way as to be inserted into the zirconium alloy tube 120; and an outer tube 130 coaxially arranged with the zirconium alloy tube 120 in such a way as to be fitted to the outer peripheral surface of the zirconium alloy tube 120, and at least one of the inner tube 110 and the outer tube 130 is made from a ferrous or non-ferrous metal.

According to one embodiment of the present disclosure, the ferrous or non-ferrous metal is stainless steel comprising 10 to 25% by weight of chromium (Cr), 5 to 20% by weight of nickel (Ni), and 0.1 to 10% by weight of molybdenum (Mo). According to another embodiment of the present disclosure, the stainless steel comprises 11, 12, or 13% or more and otherwise 24, 23, or 22% or less by weight of chromium (Cr), 6, 7, or 8% or more and otherwise 19, 18, or 17% or less by weight of nickel (Ni), and 0.3, 0.5, or 0.7% or more and otherwise 9, 8, or 7% or less by weight of molybdenum (Mo). Desirably, the ferrous or non-ferrous metal is stainless steel.

According to one embodiment of the present disclosure, the multi-layered nuclear fuel cladding according to the present disclosure further includes a zirconium nitride layer formed on at least one of the interface between the zirconium alloy tube 120 and the inner tube 110 and the interface between the zirconium alloy tube 120 and the outer tube 130. The zirconium nitride layer formed on the interface of the multi-layered nuclear fuel cladding acts as an inhibitor for preventing high temperature oxidation to suppress oxidation from being developed anymore at the inside of the multi-layered nuclear fuel cladding, and further, the formation of the zirconium nitride layer enables a risk of peeling off due to an external heat impact and a fluid flow to become remarkably lower than plating or coating onto the outer peripheral surface of the nuclear fuel cladding for the improvement of corrosion resistance.

According to one embodiment of the present disclosure, the mean thickness of the zirconium nitride layer is in the range of 0.1 to 3 μm. According to another embodiment of the present disclosure, the mean thickness of the zirconium nitride layer is greater than or equal to 0.2, 0.3, or 0.4 μm and otherwise less than or equal to 2.9, 2.8, or 2.7 μm.

According to one embodiment of the present disclosure, a thickness ratio of the zirconium nitride layer to the zirconium alloy tube is 1:100 to 250. According to another embodiment of the present disclosure, a thickness ratio of the zirconium nitride layer to the zirconium alloy tube is 1:120, 140, 160, or 180 or more and otherwise 1:240, 230, 220, 210, or 200 or less. The control of the thickness ratio of the zirconium nitride layer to the zirconium alloy tube within the above-mentioned range prevents a gap between the zirconium alloy tube and the outer tube or between the zirconium alloy tube and the inner tube from being generated through high volume expansivity of zirconium nitride.

According to one embodiment of the present disclosure, the thickness of the outer tube is in the range of 10 to 80 μm. According to another embodiment of the present disclosure, the thickness of the outer tube is greater than or equal to 20, 30, or 40 μm and otherwise less than or equal to 75, 70, or 65 μm. The control of the thickness of the outer tube within the above-mentioned range has no influence on the fission reaction of atomic energy in a nuclear reactor core and enhances thermal stability.

Hereinafter, embodiments of the present disclosure will be explained in detail so as to be easily carried out by those of ordinary skill in the art. The present disclosure may be modified in various ways and may have several exemplary embodiments. The thicknesses of the respective inner tubes, outer tubes, and zirconium alloy tubes of Embodiments and Comparative example are in the range of tolerance of ±10 μm, desirably ±5 μm, and the diameters thereof are in the range of tolerance of ±10 μm, desirably ±5 μm, unless specifically Mentioned.

### Embodiment 1. Manufacturing a Multi-Layered Nuclear Fuel Cladding

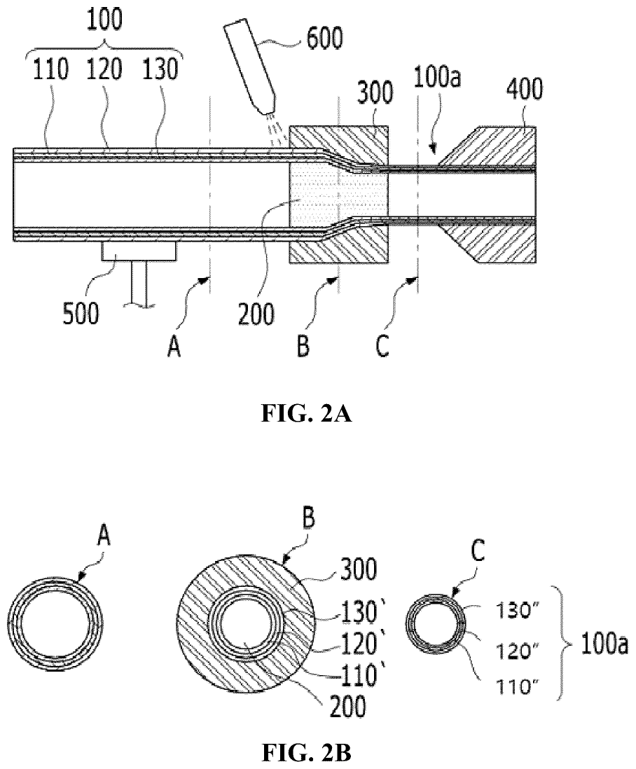

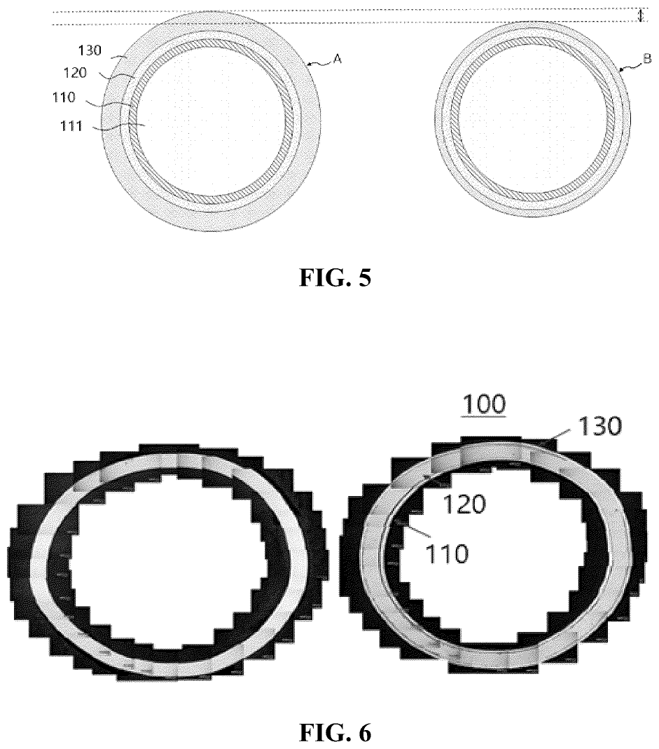

The inner tube (having a thickness of 150 μm and a diameter of 8.51 mm and made from SUS 316L) was inserted into the zirconium alloy tube (Zircaloy-4) having a thickness of 575 μm and a diameter of 9.5 mm, and next, the zirconium alloy tube was inserted into the outer tube (having a thickness of 150 μm and a diameter of 9.8 mm and made from SUS 316L), thereby preparing the preliminary cladding 100. After that, the insertion body whose both end portion have different outer diameters was inserted into the inner tube, and as shown in FIG. 5, reduction and drawing of the preliminary cladding 100 were carried out at a room temperature and an ambient pressure. The preliminary cladding 100 or the multi-layered nuclear fuel cladding 100a, which was drawn at a speed of 0.03 m/sec in the first axial direction, was divided into positions A, B, and C, and the sectional views of the respective positions are shown in FIG. 2B. It can be appreciated that while the preliminary cladding 100 being in the position A is being drawn, the thickness and diameter thereof are reduced by means of the insertion body 200 and the die 300, and as shown in the position C, the inner tube 110″ and the outer tube 130″ are brought into close contact with the zirconium alloy tube 120, so that the preliminary cladding 100 turns into a single tube, that is, the multi-layered nuclear fuel cladding 100a without any distortion. Next, centerless grinding was carried out three times, and finally, the multi-layered nuclear fuel cladding 100a having a thickness of 795 μm and a diameter of 9.5 mm or less was made (See the right side of FIG. 6). In this case, the thickness of the inner tube was 150 μm, the thickness of the outer tube was 70 μm, and the thickness of the zirconium alloy tube (Zircaloy-4) was 575 μm.

### Embodiment 2. Manufacturing a Multi-Layered Nuclear Fuel Cladding

A multi-layered nuclear fuel cladding was made in the same manner as in Embodiment 1, except that an inner tube (having a thickness of 70 μm and a diameter of 8.51 mm and made from SUS 316L) having pre-polishing was used, and the last centerless grinding of Embodiment 1 was omitted.

In this case, the multi-layered nuclear fuel cladding made had a thickness of 715 μm and a diameter of 9.5 mm or less. Further, the thickness of the inner tube was 70 μm, the thickness of the outer tube was 70 μm, and the thickness of the zirconium alloy tube (Zircaloy-4) was 575 μm.

### Embodiment 3. Manufacturing a Multi-Layered Nuclear Fuel Cladding Having a Zirconium Nitride Layer

The multi-layered nuclear fuel cladding made in Embodiment 1 was subjected to a heat treatment using heating equipment (product name JTF-Q made by J-One Co., Ltd.) at a temperature of 863° C. for 24 hours, thereby producing a zirconium nitride layer having the mean thickness of 3 μm or less.

After the production of the zirconium nitride layer, in this case, the multi-layered nuclear fuel cladding made had a thickness of 718 μm or less and a diameter of 9.51 mm or less. Further, the thickness of the inner tube was 70 μm, the thickness of the outer tube was 70 μm, the thickness of the zirconium alloy tube (Zircaloy-4) was 575 μm, and the mean thickness of the zirconium nitride layer was 3 μm.

### Comparative Example 1. Manufacturing a Single-Layered Nuclear Fuel Cladding

A single-layered nuclear fuel cladding having a thickness of 575 μm and a diameter of 9.6 mm or less was made in the same manner as in Embodiment 1, except that an inner tube and outer tube were not used (See the left side of FIG. 6).

### Experimental Example 1. Thermal Stability Analysis

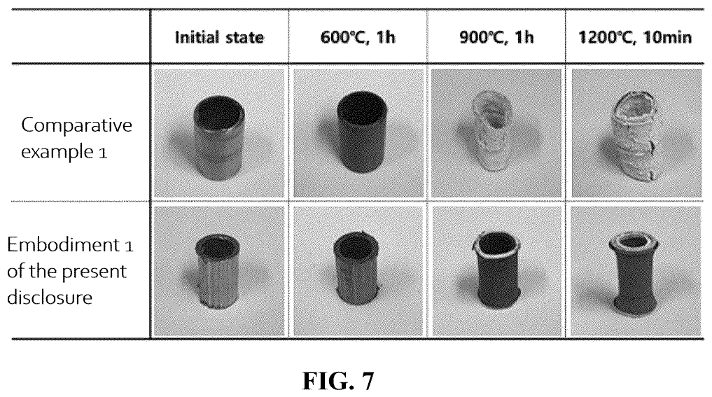

The nuclear fuel claddings made in Embodiment 1 and Comparative example 1 were heated using a furnace at temperatures of 600° C. and 900° C. for one hour and next heated again at a temperature of 1200° C. for 10 minutes, thereby analyzing the oxidized (damaged) states thereof. As a result, as shown in FIG. 7, it is found that at a high temperature of 900° C. or more, the multi-layered nuclear fuel cladding has better thermal stability than the single-layered nuclear fuel cladding. Air exists in the cladding during the reduction and drawing processes of the cladding, but the zirconium nitride (ZrN) layer produced at a temperature of 900° C. or more serves as an inhibitor for preventing high temperature oxidation, so that oxidation is not developed anymore inside the cladding.

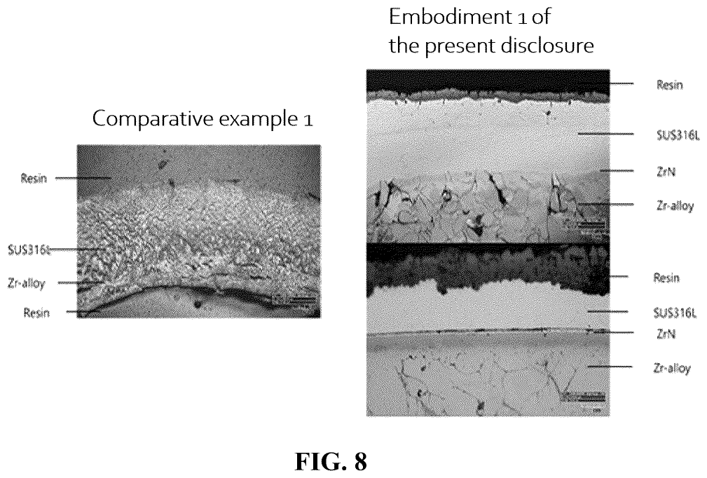

If the zirconium nitride (ZrN) layer is additionally formed on the interface between the layers of the multi-layered nuclear fuel cladding, it can be expected that oxidation resistance is improved, and the heating result of the nuclear fuel cladding made in Embodiment 3 through the same equipment at a temperature of 1200° C. for 10 minutes is shown in FIG. 8. In the case of Comparative example 1 where the zirconium nitride (ZrN) layer is not formed, that is, the zirconium alloy tube (Zircaloy-4) has low oxidation resistance at a high temperature, thereby causing the nuclear fuel cladding to be damaged, and in the case of Embodiment 3 where the zirconium nitride (ZrN) layer is formed, contrarily, the zirconium alloy tube (Zircaloy-4) has high oxidation resistance at a high temperature.

The method for manufacturing the multi-layered nuclear fuel cladding according to one embodiment of the present disclosure and the multi-layered nuclear fuel cladding made by the same method allow the bullet-shaped insertion body to be inserted into the inner tube so that a given force is applied to the inside of the preliminary cladding to cause the thickness and diameter of the preliminary cladding to be reduced, thereby applying the reaction force to the force applied to the inside of the preliminary cladding to the inner tube to thus permit the inner tube to be fixedly brought into close contact with the outer tube and finally manufacturing the multi-layered nuclear fuel cladding as a single tube, without having any boundary between the inner tube and the outer tube.

Further, the bullet-shaped insertion body applies the given force when the inner peripheral surface of the inner tube entirely comes into contact with the outer peripheral surface thereof, so that the insertion body is located at the center of the inner tube, coaxially with the preliminary cladding, while applying the reaction force to the inner tube in a state of being coaxial with the inner tube and the outer tube, thereby manufacturing the multi-layered nuclear fuel cladding as a single tube where the inner tube and the outer tube are coaxial with each other.

Furthermore, the bullet-shaped insertion body whose both end portions have different outer diameters is fixed by the die fitted to the outer peripheral surface of the preliminary cladding to allow the multi-layered nuclear fuel cladding to be continuously made through a drawing process, without being limited in length of the preliminary cladding, thereby enabling the multi-layered nuclear fuel cladding having a very long length of several to tens of meters to be manufactured. Besides, if the drawing process of the preliminary cladding is completed, the bullet-shaped insertion body located inside the preliminary cladding is locked onto the die, and accordingly, if the manufacturing process of the multi-layered nuclear fuel cladding is completed, the insertion body is removable simply from the preliminary cladding to the outside, without any additional device or method.

Further, the multi-layered nuclear fuel cladding comprising zirconium alloy and stainless steel has excellent thermal stability at a high temperature, thereby improving stability at the occurrences of abnormal operations and severe accidents of a nuclear power plant.

As described above, the method for manufacturing the multi-layered nuclear fuel cladding according to the present disclosure can manufacture the multi-layered nuclear fuel cladding made from the zirconium alloy and the ferrous or non-ferrous metal using the bullet-shaped insertion body with ease, thereby ensuring the multi-layered nuclear fuel cladding having excellent thermal stability at a high temperature.

The effectiveness of the present disclosure is not limited as mentioned above, and it should be understood to those skilled in the art that the effectiveness of the present disclosure may include another effectiveness as not mentioned above from the detailed description of the present disclosure.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above teachings. For example, the parts expressed in a singular form may be dispersedly provided, and in the same manner as above, the parts dispersed may be combined with each other.

It is therefore intended that the scope of the disclosure be limited not by this detailed description, but rather by the claims appended hereto. It is to be appreciated that those skilled in the art can change or modify the embodiments without departing from the scope and spirit of the present disclosure.

What is claimed is:

1. A method for manufacturing a multi-layered nuclear fuel cladding, the method comprising the steps of:
preparing a preliminary cladding by inserting an inner tube into a zirconium alloy tube extending in a first axial direction in such a way as to allow the inner tube to be coaxially arranged with the zirconium alloy tube and by fitting an outer tube to the zirconium alloy tube in such a way as to allow the outer tube to be coaxially arranged with the zirconium alloy tube;
inserting a bullet-shaped insertion body whose both end portions have different outer diameters into the inner tube; and
applying a given force to the preliminary cladding to reduce the thickness and diameter of the preliminary cladding,
wherein at least one of the inner tube and the outer tube is made from a ferrous or non-ferrous metal.

2. The method according to claim 1, wherein the step of preparing the preliminary cladding further comprises the step of forming a zirconium nitride layer on at least one among the inner peripheral surface and (or) the outer peripheral surface of the zirconium alloy tube, the outer peripheral surface of the inner tube, and the inner peripheral surface of the outer tube.

3. The method according to claim 2, wherein the step of forming the zirconium nitride layer is performed by means of gas nitriding, plasma nitriding, or heat nitriding at a temperature in the range of a room temperature to 2500° C.

4. The method according to claim 1, further comprising the step of forming, after the step of reducing the thickness and diameter of the preliminary cladding, a zirconium nitride layer on at least one of the interface between the zirconium alloy tube and the inner tube and the interface between the zirconium alloy tube and the outer tube.

5. The method according to claim 4, wherein the step of forming the zirconium nitride layer is performed by means of thermal treatment in the range of 300 to 1000° C. for 1 to 50 hours.

6. The method according to claim 3, wherein a mean thickness of the zirconium nitride layer of the multi-layered nuclear fuel cladding is in the range of 0.01 to 100 μm.

7. The method according to claim 1, wherein the insertion body comprises:
a front end portion having the shape of a cylinder with a first outer diameter;
a rear end portion having the shape of a cylinder with a second outer diameter larger than the first outer diameter; and
an inclined portion for connecting the front end portion and the rear end portion to each other, and
the step of inserting the insertion body into the inner tube is performed by first inserting the front end portion into the inner tube.

8. The method according to claim 1, wherein the step of reducing the thickness and diameter of the preliminary cladding comprises the steps of:
inserting the preliminary cladding into a through hole formed on a die fixed to a given position, the though hole having an inner peripheral shape corresponding to the outer peripheral shape of the insertion body; and
drawing the front end portion of the preliminary cladding along the first axial direction.

9. The method according to claim 8, wherein the through hole comprises:
a first through hole having the shape of a cylinder with a first inner diameter;
a second through hole having the shape of a cylinder with a second inner diameter larger than the first inner diameter; and
an inclined tube hole for connecting the first through hole and the second through hole to each other, and
the first inner diameter being larger than the first outer diameter of the insertion body, the second inner diameter being larger than the second outer diameter of the insertion body, and the second outer diameter of the insertion body being larger than the first inner diameter.

10. The method according to claim 8, wherein the step of reducing the thickness and diameter of the preliminary cladding further comprises the step of reducing the front end portion of the preliminary cladding in such a way as to allow the front end portion of the preliminary cladding to be inserted into the through hole and then protrude outward from the front end portion of the die.

11. The method according to claim 8, wherein the hardness of the insertion body and the die is 2 to 5 times greater than the mean hardness of the preliminary cladding.

12. The method according to claim 1, further comprising at least one of steps of grinding the surface of the insertion body and applying a lubricant to the surface of the insertion body.

13. The method according to claim 7, wherein the inclined portion has an inclination in the range of 10 to 35° with respect to the extension line of the outer surface of the front end portion.

14. The method according to claim 7, wherein the height of the front end portion is 1/10 to ⅓ of the entire height of the insertion body.

15. The method according to claim 1, wherein the step of reducing the thickness and diameter of the preliminary cladding further comprises the step of grinding or polishing the preliminary cladding.

16. The method according to claim 1, wherein the step of preparing the preliminary cladding further comprises the step of grinding or polishing the zirconium alloy tube, the preliminary cladding, the inner tube, or the outer tube.

17. The multi-layered nuclear fuel cladding manufactured by the method according to claim 1, the nuclear fuel cladding comprising:
a zirconium alloy tube extending in a first axial direction;
a hollow inner tube coaxially arranged with the zirconium alloy tube in such a way as to be inserted into the zirconium alloy tube; and
an outer tube coaxially arranged with the zirconium alloy tube in such a way as to be fitted to the outer peripheral surface of the zirconium alloy tube,
wherein at least one of the inner tube and the outer tube is made from a ferrous or non-ferrous metal.

18. The multi-layered nuclear fuel cladding according to claim 17, further comprising a zirconium nitride layer formed on at least one of the interface between the zirconium alloy tube and the inner tube and the interface between the zirconium alloy tube and the outer tube.

19. The method according to claim 5, wherein a mean thickness of the zirconium nitride layer of the multi-layered nuclear fuel cladding is in the range of 0.01 to 100 μm.
